(19) United States
(12) Patent Application Publication
(10) Pub. No.: US 2010/0318588 A1
(43) Pub. Date: Dec. 16, 2010

(54) Spatial-Temporal Event Correlation for Location-Based Services

(75) Inventors: John Buford, Princeton, NJ (US); Venkatesh Krishnaswamy, Holmdel, NJ (US); Xiaotao Wu, Metuchen, NJ (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/484,083

(22) Filed: Jun. 12, 2009

(51) Int. Cl. G06F 17/30

(52) U.S. Cl. 707/955; 707/959

(57) ABSTRACT

A method for tracking the context around moving objects without some of the disadvantages of the prior art is disclosed. This is done by correlating the spatial information of what is around an object with the temporal (or time) information of an object's movements.

### CROSS REFERENCE TO RELATED APPLICATIONS

This application is related to U.S. patent application Ser. No. ______, entitled “Location Privacy Enforcement in a Location-Based Services Platform,” (Attorney Docket “630-409us”) filed on the same date as this application, which is incorporated by reference.

If there are any contradictions or inconsistencies in language between this application and the cases that have been incorporated by reference that might affect the interpretation of the claims in this case, the claims in this case should be interpreted to be consistent with the language in this case.

### FIELD OF THE INVENTION

The present invention relates to telecommunications in general, and, more particularly, to location-based services.

### BACKGROUND OF THE INVENTION

Location-based services are services provided based on the location of objects. The most prevalent location-based service is Enhanced 911 (or E911) services. The Enhanced 911 service provides 911 operators and emergency responders with information such as the identification of the person calling and the location of the caller. All mobile telephones sold in the United States today have this feature.

Location-based services include, for example and without limitation, satellite navigation devices that let a user know the location of the closest hospital or gas station to a user. Location-based services may also alert enterprises, such as gas stations, as to when a potential customer is within a certain distance. The enterprise may then send targeted advertisements to a traveler, such as discounts, etc.

Still other location-based services are targeted to the tracking of objects, such as, for example and without limitation, tracking of packages, tracking a fleet of vehicles, or determining the number of people who are in a given area for allotting government services where they may be most needed.

Keeping track of these moving objects is difficult enough, but there is a problem when providing location-based services relating to a multitude of moving objects. Namely, how to keep track of the objects around the objects. Or, in other words: How do we track the context around moving objects?

Keeping track of stationary objects is performed by the use of geographic information systems. Stationary objects are objects such as, for example and without limitation, roads, buildings, etc. These systems are databases which keep track of the space around a given location. Common geographic information systems include Google Maps and the points of interest database on a satellite navigation device. These are limited devices in that they are limited by memory access times relative to the movement of a vehicle, especially as the object tracked moves through multiple areas.

### SUMMARY OF THE INVENTION

The present invention provides a method of tracking the context around moving objects without some of the disadvantages of the prior art. This is done by correlating the spatial information of what is around an object with the temporal (or time) information of an object's movements.

The present invention does this in two ways. First, it takes advantage of an “event processor.” Event processors are systems of hardware and software that are used to deal with large amounts of time-sensitive data. Examples of the uses of event processors are in financial institutions that track queries such as: “How many transactions involving stock X have transpired in the last 20 minutes?” or “How many stocks are down right now?” These are time-sensitive, contextual queries. Event processors are also used in the management of telecommunications networks.

Event processors are designed to be able to handle the large amounts of data produced by the myriad of financial transactions in various markets across the world. In the illustrative embodiment of the present invention, an event processor is used to track the movements of a myriad of objects traveling across a given space.

By combining these time-sensitive event-handling abilities of an event processor with the location context provided by a database, the present invention provides a method for providing context to location- and time-sensitive events.

Secondly, the illustrative embodiment of the present invention does this by employing a second database to handle the geographic features of the geographic information system database without some of the disadvantages of the prior art. Sometimes, these geographic information systems are “black boxes,” that cannot be interfaced directly and only through an intermediary. This means that interfacing with the databases may have inefficiencies. These systems are also large systems, comprising a lot of data that is not specifically targeted. For example, and without limitation, the geographic information may comprise information such as the price of gasoline at the closest gas station, or the reviews of the closest pizza parlors. This information is often useful, but may slow down a contextual search.

The illustrative embodiment of the present invention is able to handle queries such as, for example, and without limitation, “Inform me when 200 objects are inside of area 101-2 at the same time,” or “Inform me when object 201-1 and 202-2 are in space 101-5.” Some more concrete examples of spatial-temporal event correlation are presented, without limitation, in table 1:

TABLE 1
Comparison of Temporal Event Correlations, Spatial Event Correlations, and
Spatial-Temporal Event Correlations

| | Temporal Event | Spatial Event | Spatial-Temporal Event |
|---|---|---|---|
| Category | Correlation | Correlation | Correlation |
| Event in window/ | An event from a | Target has entered | Target has left and |
| region | specified source | space of interest | returned to space of |
| | occurred in a time | | interest n times in a |
| | window W | | given time period |
| Count | Event count in time | Target density in | Number of targets that |
| | window | space of interest | were in space of interest |
| | | now | during some time window |
| | | | Number of targets that |
| | | | moved through the space |
| | | | of interest during some |
| | | | time window with a |
| | | | velocity > v |
| Related Events/ | 2 related events | 2 targets have | 2 targets have similar |
| Objects | from different | possible common | movement trajectory in |
| | sources occur in | meeting point at | space of interest in time |
| | window W | position P | window W |
| Proximity | 2 or more related | 2 or more specified | 2 or more specified |
| | events occur within | targets are in space | targets are in space of |
| | some interval | of interest | interest within some time |
| | | | interval |
| Ordering | 2 events have a | 2 targets have a | 2 targets have a specified |
| | specified temporal | specified spatial | spatial relationship with |
| | relationship such as | relationship such as | related events from these |
| | x begins y, x | at, above, or | targets having a specified |
| | overlaps y, etc. | contains. | temporal relationship |
| Statistical | Average number of | Average number of | Average number of |
| | events of a given | targets of a given | targets of a given type or |
| | type or other | type or with | with specified properties |
| | properties across | specified properties | across multiple spaces of |
| | multiple time | across multiple | interest and time |
| | windows | spaces of interest | windows |

The ability to correlate across both time and space can be important for applications. For example and without limitation, “Target has left and returned to space of interest n times in time window W” could mean that a customer is close to a purchase decision, and “2 targets have similar movement trajectory in space in time window W” could be used to automatically detect a stalker.

### BRIEF DESCRIPTION OF THE DRAWINGS

FIG. 1 depicts a map in accordance with the illustrative embodiment of the present invention.

FIG. 2 depicts a map in accordance with the illustrative embodiment of the present invention.

FIG. 3 depicts a map in accordance with the illustrative embodiment of the present invention.

FIG. 4 depicts a schematic diagram of the salient components of spatial-temporal event correlation system 400 in accordance with the illustrative embodiment of the present invention.

FIG. 5 depicts a schematic diagram of the salient components of a spatial-temporal event correlation system 400 in accordance with the illustrative embodiment of the present invention.

FIG. 6 depicts a schematic diagram of the salient components of a spatial-temporal event correlation system 400 in accordance with an alternative embodiment of the present invention.

FIG. 7 depicts a flowchart of the salient tasks associated with the operation of the illustrative embodiment of the present invention.

FIG. 8 depicts a flowchart of the salient tasks associated with the operation of task 707 in accordance with the illustrative embodiment of the present invention.

FIG. 9 depicts a flowchart of the salient tasks associated with the operation of task 801 in accordance with the illustrative embodiment of the present invention.

FIG. 10 depicts a flowchart of the salient tasks associated with the operation of task 711 in accordance with the illustrative embodiment of the present invention.

FIG. 11 depicts a flowchart of the salient tasks associated with the operation of task 1001 in accordance with the illustrative embodiment of the present invention.

### DETAILED DESCRIPTION

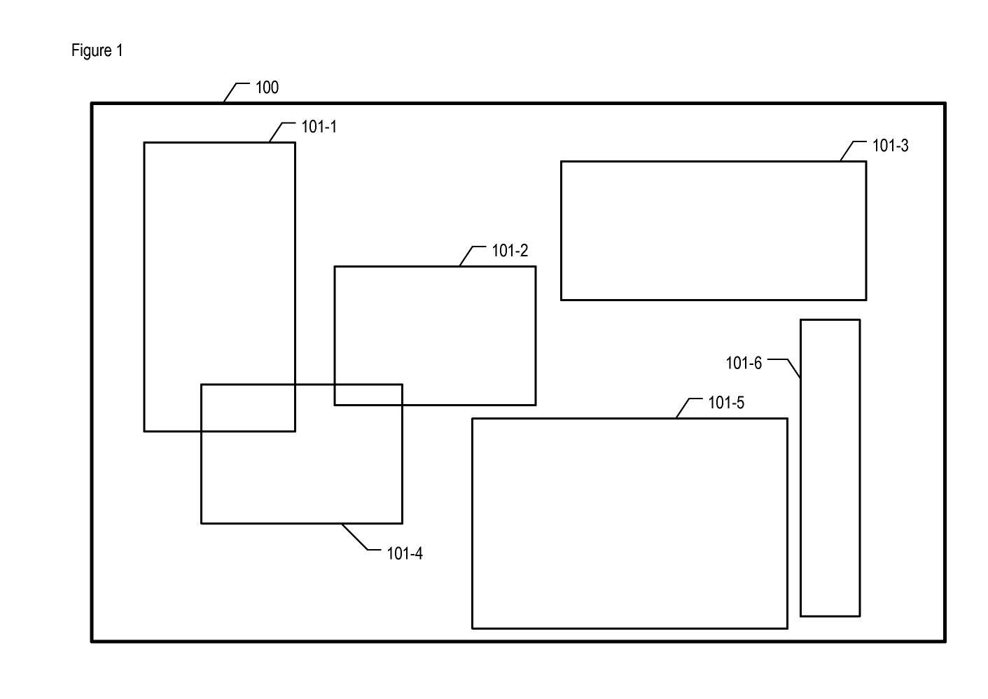

FIG. 1 depicts a map in accordance with the illustrative embodiment of the present invention.

Map 100 is a rectangular area in which we are interested for the purposes of the illustrative embodiment of the present invention. Map 100 comprises areas 101-1 through 101-6.

Although, in accordance with the illustrative embodiment of the present invention, map 100 represents some physical space, it will be clear to one skilled in the art after reading this disclosure, how to make and use alternative embodiments of the present invention in the space is not a physical space, for example and without limitation, the space is instead a virtual space.

Although, in accordance with the illustrative embodiment of the present invention, map 100 represents space in two dimensions (2-D), it will be clear to one skilled in the art after reading this disclosure, how to make and use alternative embodiments of the present invention in the space is not a two dimensional (2-D) space but instead the space is any number of dimensions, for example and without limitation, three dimensions (3-D), four dimensions (4-D), etc.

Although map 100 is a rectangular area, it will be clear to one skilled in the art after reading this disclosure, how to make and use alternative embodiments of the present invention in which map 100 is any shape or any size.

Although areas 101-1 through 101-6 are a rectangular areas, it will be clear to one skilled in the art, after reading this disclosure, how to make and use alternative embodiments of the present invention in which areas 101-1 through 101-6 are any shape or any size.

Although areas 101-1 and 101-4 overlap, it will be clear to one skilled in the art, after reading this disclosure, how to make and use alternative embodiments of the present invention in which areas 101-1 and 101-4 do not overlap, overlap completely, or overlap with other areas.

Although areas 101-2 and 101-4 overlap, it will be clear to one skilled in the art, after reading this disclosure, how to make and use alternative embodiments of the present invention in which areas 101-2 and 101-4 do not overlap, overlap completely, or overlap with other areas. It will also be clear to one skilled in the art, after reading this disclosure, how to make and use alternative embodiments of the present invention

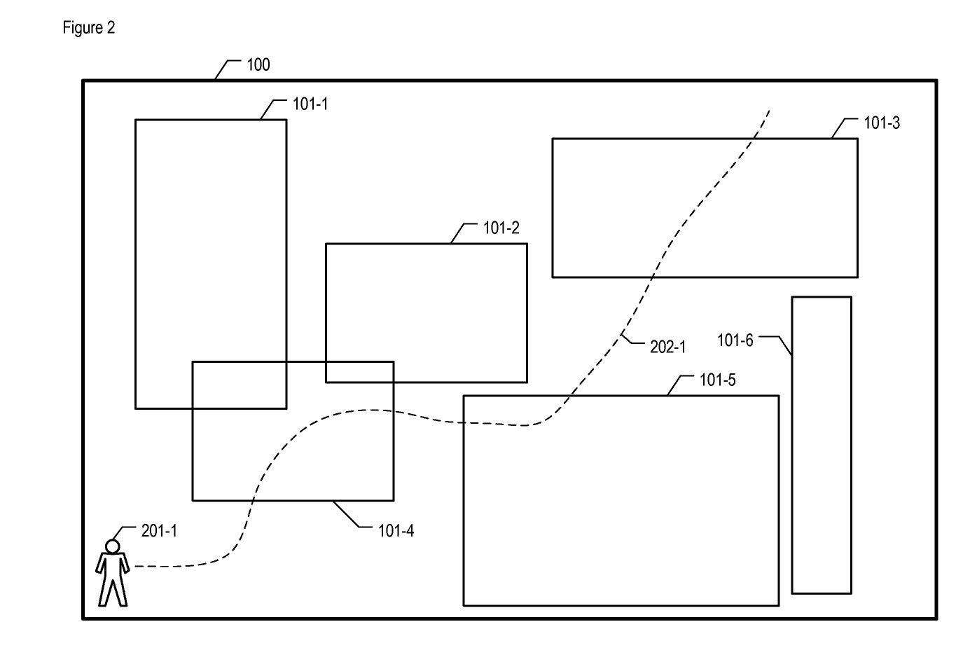

FIG. 2 depicts a map in accordance with the illustrative embodiment of the present invention. Map 100 comprises areas 101-1 through 101-6, object 201-1, and path 202-1.

Although FIG. 2 depicts one object, it will be clear to one skilled in the art, after reading this disclosure, how to make and use alternative embodiments of the present invention in which there are any number of objects.

Although FIG. 2 depicts one path, it will be clear to one skilled in the art, after reading this disclosure, how to make and use alternative embodiments of the present invention in which there are any number of paths.

Although object 201-1 is depicted as a person, it will be clear to one skilled in the art, after reading this disclosure, how to make and use alternative embodiments of the present invention in which object 201-1 can be any object, for example, and without limitation: a person, a sensor, a vehicle, an animal, a telecommunications terminal, a stationary object, etc.

Although path 202-1 is depicted as going through areas 101-4, 101-5, and 101-3 of the map, it will be clear to one skilled in the art, after reading this disclosure, how to make and use alternative embodiments of the present invention in which path 202-1 can travel through any area of map 100.

Although object 201-1 is depicted as traveling along path 202-1, it will be clear to one skilled in the art, after reading this disclosure, how to make and use alternative embodiments of the present invention in which object 201-1 can travel along any path and through any area of map 100.

In accordance with the illustrative embodiment of the present invention, object 201-1 travels along path 202-1 through areas 101-4, 101-5, and 101-3 of map 100 As it travels along this path, the location object 201-1 is noted and tracked. In accordance with the illustrative embodiment of the present invention, the location is noted by satellite trilateralization, such as, for example, and without limitation, global positioning system (GPS). Other techniques for determining location include, for example and without limitation, triangulation of endpoints in cellular or wireless networks, proximal device broadcast, purchasing transactions (such as those by credit card or debit card), vehicle-to-vehicle networks, radio signals, etc. In accordance with the illustrative embodiment of the present invention, the location is then tracked by sending periodic updates through a wireless network, such as, for example and without limitation, a mobile telephone or data network, a packet radio network, a IEEE 802.11 (Wi-Fi) network, etc.

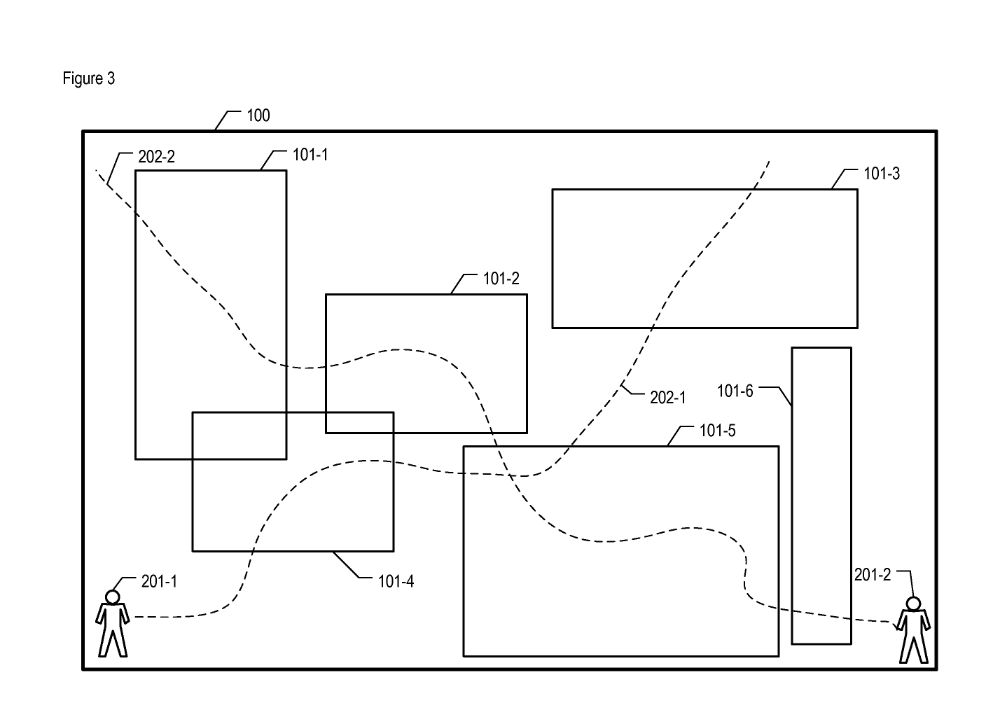

FIG. 3 depicts a map in accordance with the illustrative embodiment of the present invention. Map 100 comprises areas 101-1 through 101-6, objects 201-1 and 201-2, and paths 202-1 and 202-2.

Although path 202-2 is depicted as going through areas 101-6, 101-5, 101-2 and 101-1 of the map, it will be clear to one skilled in the art, after reading this disclosure, how to make and use alternative embodiments of the present invention in which path 202-2 can travel through any area of map 100.

Although object 201-2 is depicted as traveling along path 202-2, it will be clear to one skilled in the art, after reading this disclosure, how to make and use alternative embodiments of the present invention in which object 201-2 can travel along any path and through any area of map 100.

In accordance of the illustrative embodiment of the present invention, the object 201-1 and object 201-2 are both traveling within map 100 and go about their independent paths.

In accordance of the illustrative embodiment of the present invention, the object 201-1 and object 201-2 may (or may not) cross paths or may be (or may not be) in the same area at the same time.

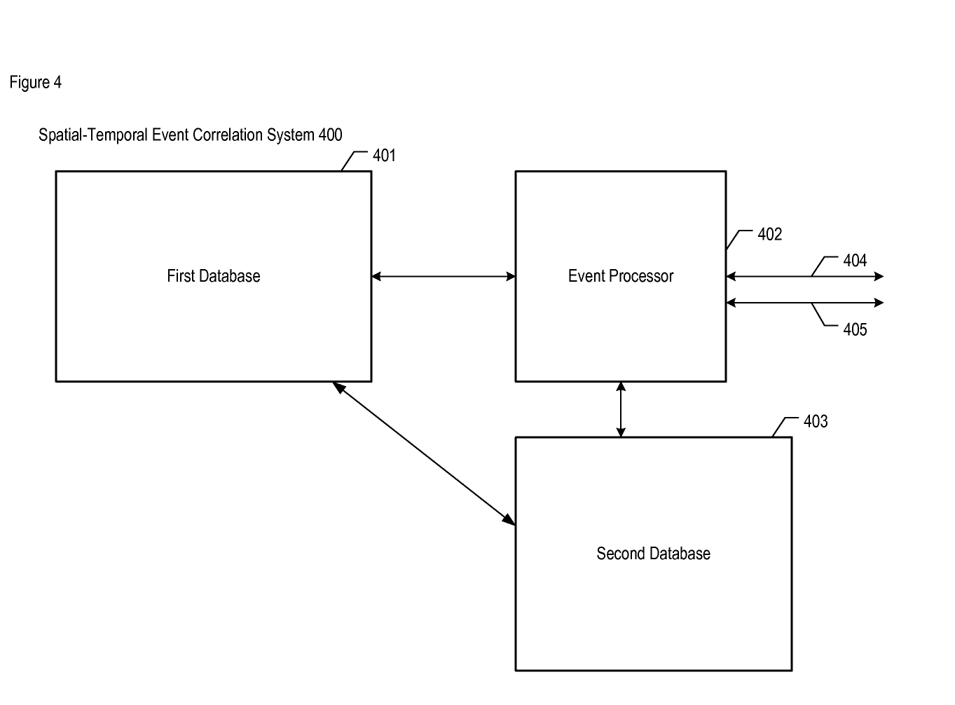

FIG. 4 depicts a schematic diagram of the salient components of spatial-temporal event correlation system 400 in accordance with the illustrative embodiment of the present invention. FIG. 4 comprises first database 401, event processor 402, second database 403, link 404, and link 405. It will be clear to one skilled in the art, after reading this disclosure, how to make and use spatial-temporal event correlation system 400.

Although FIG. 4 depicts two databases, it will be clear to one skilled in the art, after reading this disclosure, how to make and use alternative embodiments of the present invention in which there are any number of databases.

Although FIG. 4 depicts one event processor, it will be clear to one skilled in the art, after reading this disclosure, how to make and use alternative embodiments of the present invention in which there are any number of event processors.

Although first database 401 and second database 403 can communicate directly with one another, it will be clear to one skilled in the art, after reading this disclosure, how to make and use alternative embodiments of the present invention in which the first database 401 and second database 403 communicate with one another by another means, for example and without limitation, through event processor 402, through a separate application interface, etc.

In accordance with the illustrative embodiment of the present invention, an event is a tuple with fields, for example and without limitation, unique identifier, time of occurrence (either interval or point), and one or more properties. These properties may include information, for example and without limitation, the source of the event, the event type, priority, and attributes of the event or the source. An event stream is a sequence of events from the same source. It will be clear to one skilled in the art, after reading this disclosure, how to make and use alternative embodiments of the present invention in which events have different properties and fields.

In accordance with the illustrative embodiment of the present invention, event processor 402 is hardware and software that performs event processing, event filtering, and event correlation.

In accordance with the illustrative embodiment of the present invention, event processing refers to operations performed by an information system, for example and without limitation, operations to receive, distribute, store, modify, generate, or discard events. In accordance with the illustrative embodiment of the present invention, event filtering is a type of event processing in which an event is forwarded or blocked to a recipient based on a property of the event or some other computational context.

In accordance with the illustrative embodiment of the present invention, event correlation is a type of event processing in which an event is evaluated primarily with respect to other events but also system state or context, in order to produce related events. These related events ideally have the characteristics that there is a reduction in the volume of events and/or the information content of the new events is transformed to a more relevant value.

It will be clear to one skilled in the art, after reading this disclosure, how to make and use event processor 402.

In accordance with the illustrative embodiment of the present invention, first database 401 is a geographic information system (GIS) and can be interfaced with event processor 402 and with second database 403. In accordance with the illustrative embodiment of the present invention, the geographic information system can be a closed system which is interfaced by means of an application programming interface (API) or other interface that allows queries to first database 401. It will be clear to one skilled in the art, after reading this disclosure, how to make and use first database 401.

In accordance with the illustrative embodiment of the present invention, event processor 402 is software that is suited for handling queries related to ongoing events. These events, or streams of events, come in one after another and the data from these events are compared with the queries handled by event processor 402.

In accordance with the illustrative embodiment of the present invention, this would be accomplished by maintaining operations such as, for example and without limitation, “Alert me when object 201-1 and object 201-2 are in area 101-5 of map 100.” Each time object 201-1 or object 201-2 relays information to event processor 402, the operation is performed on the relayed data. It will be clear to one skilled in the art, after reading this disclosure how to make and use event processor 402.

In accordance with the illustrative embodiment of the present invention, Second Database 403 is used to store geographic information relevant to the queries of event processor 402. In accordance with the illustrative embodiment of the present invention, second database 403 comprises a subset of the information contained in first database 401.

In accordance with the illustrative embodiment of the present invention, link 404 and link 405 are links between geographic system 400 and any users of geographic information system 400. In accordance with the illustrative embodiment of the present invention, link 404 is used for event processor 402 to receive requests, for example and without limitation, subscription requests, specific triggers, correlation requests, etc. In accordance with the illustrative embodiment of the present invention, link 404 is used for event processor 402 to transmit responses, for example and without limitation, transmitting a response when a condition is met, transmitting information regarding a particular space, etc.

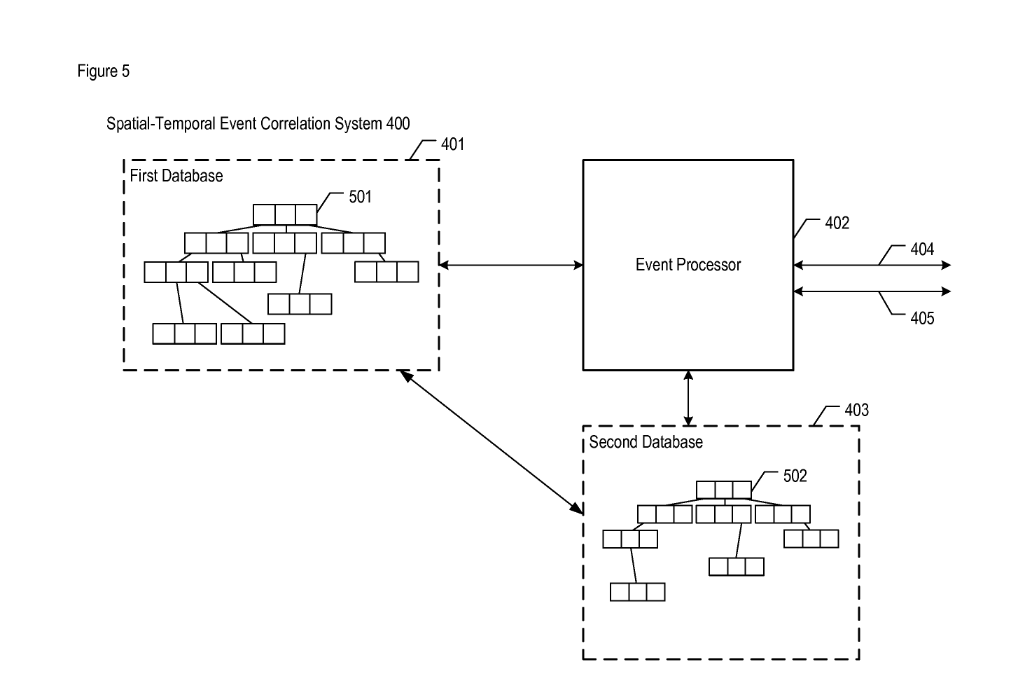

FIG. 5 depicts a schematic diagram of the salient components of a spatial-temporal event correlation system 400 in accordance with the illustrative embodiment of the present invention. FIG. 5 comprises a first database 401, an event processor 402, second database 403, link 404, and link 405

It will be clear to one skilled in the art, after reading this disclosure, how to make and use spatial-temporal event correlation system 400.

In accordance with the illustrative embodiment of the present invention, first database 401 and second database 403 are each implemented by means of an R-Tree. In accordance with the illustrative embodiment of the present invention, an R-Tree is a data structure that is suited for indexing geographic coordinates. It will be clear to one skilled in the art, after reading this disclosure, how to make and use R-Trees.

Although first database 401 and second database 403 are implemented by means of an R-Tree, it will be clear to one skilled in the art, after reading this disclosure, how to make and use alternative embodiments of the present invention in which either first database 401 and second database 403 are implemented by another means, for example, and without limitation, an R*-Tree, an R⁺-Tree, a B-Tree, a quad-tree, a hash table, a moving object index, or any data storage structure or method.

Although the R-Tree in first database 401 and the R-tree in second database 402 comprise three entries for each node, it will be clear to one skilled in the art, after reading this disclosure how to make and use alternative embodiments of the present invention in which there are any number of entries for each node.

Although the R-Tree in first database 401 and the R-tree in second database 402 comprise three child nodes for each parent node, it will be clear to one skilled in the art, after reading this disclosure how to make and use alternative embodiments of the present invention in which there are any number of child nodes for each parent node.

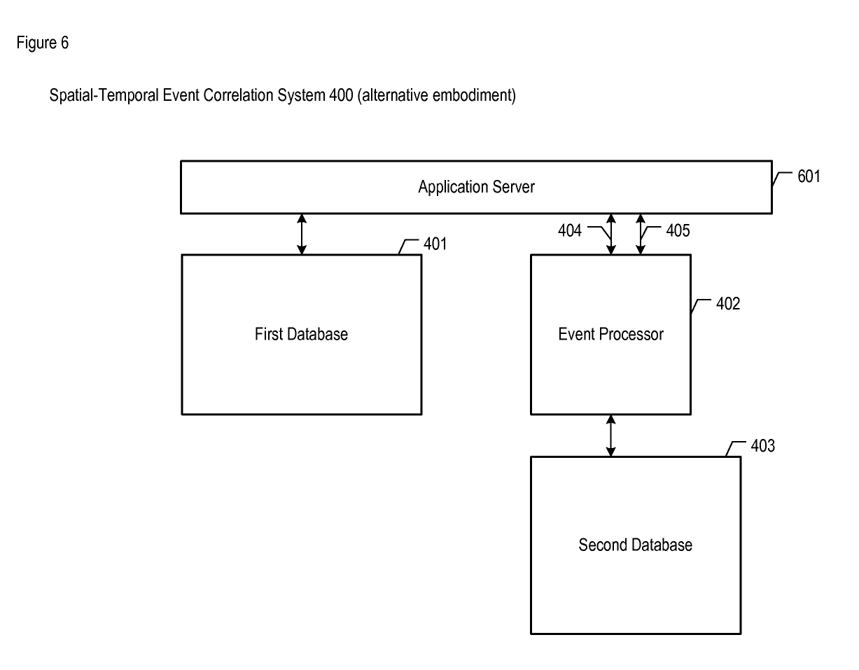

FIG. 6 depicts a schematic diagram of the salient components of a spatial-temporal event correlation system 400 in accordance with an alternative embodiment of the present invention. FIG. 6 comprises a first database 401, an event processor 402, second database 403, link 404, link 405, and application server 601.

Although accordance with the alternative embodiment of the present invention, application server 601 interfaces with first database 401 and with event processor 402, it will be clear to one skilled in the art, after reading this disclosure, how to make and use spatial-temporal event correlation system 400 in which the components communicate with one another by another means, for example and without limitation, through event processor 402, etc.

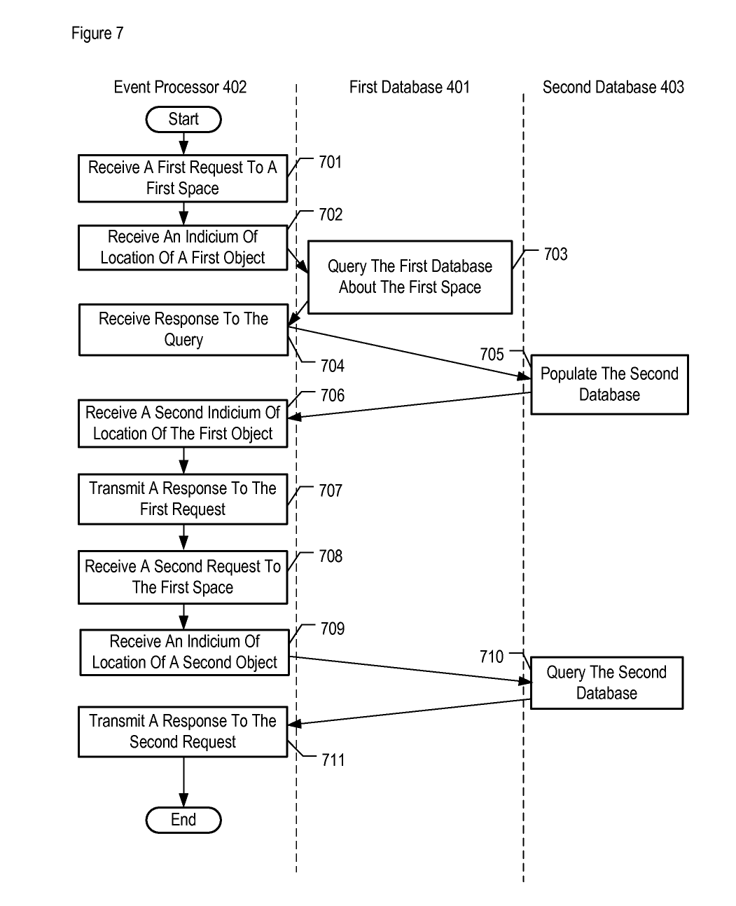

FIG. 7 depicts a flowchart of the salient tasks associated with the operation of the illustrative embodiment of the present invention.

In accordance with the illustrative embodiment of the present invention, tasks 701, 702, 704, 706, 707, 708, 709, 711 are performed at event processor 402. However, it will be clear to one skilled in the art, after reading this disclosure how to make and use other implementations of the present invention in which the some or all of the steps are performed by another device, for example, and without limitation, a separate application interface, first database 401, second database 403, etc.

In accordance with the illustrative embodiment of the present invention, task 703 is performed at first database 401. However, it will be clear to one skilled in the art, after reading this disclosure how to make and use other implementations of the present invention in which the step is performed by another device, for example, and without limitation, a separate application interface, etc.

In accordance with the illustrative embodiment of the present invention, tasks 705 and 610 are performed at second database 402. However, it will be clear to one skilled in the art, after reading this disclosure how to make and use other implementations of the present invention in which the steps are performed by another device, for example, and without limitation, first database 401, at event processor 402, a separate application interface, etc.

At task 701, a first request is made to a first space at event processor 402. In accordance with the illustrative embodiment of the present invention, the first space is a geographic space defined by X and Y coordinates and is referred to by a name, such as, for example and without limitation, space 101-5 in map 100.

Although, in accordance with the illustrative embodiment of the present invention, the space is defined in two dimensions (2-D) using Cartesian X and Y coordinates, it will be clear to one skilled in the art after reading this disclosure, how to make and use alternative embodiments of the present invention in the space is defined in more than two dimensional (2-D) space, for example and without limitation, three dimensions (3-D), four dimensions (4-D), etc.

Although, in accordance with the illustrative embodiment of the present invention, the space is referred to by a name (space 101-5), it will be clear to one skilled in the art, after reading this disclosure how to make and use alternative embodiments of the present invention in which the space is referred to directly using its X and Y coordinates, by giving a center point and a radius of the space around that point, by referring to the space using some other coordinate system, by referring to the space using some other naming system, etc.

It will be clear to one skilled in the art, after reading this disclosure, how to make and use alternative embodiments of the present invention that perform task 701.

At task 702, event processor 402 receives a first indicium of the location of a first object.

In accordance with the illustrative embodiment of the present invention, an indicium of the location of the first object is some indication of where the first object may be located. These are, for example, and without limitation, the name of the object to be located, the X and Y coordinates at which the object is located, a name for the place where the object is located (such as “home,” “work,” “school,” etc.), a store where a purchase may have occurred, or any signal that may tell where the object is located.

In accordance with the illustrative embodiment of the present invention, the location is in geographic space defined by X and Y coordinates and is referred to by a name, such as, for example and without limitation, object 201-1 in map 100.

In accordance with the illustrative embodiment of the present invention, the first indicium of the first object is received at an initial time i. It will be clear to one skilled in the art, after reading this disclosure how to make alternative embodiments of the present invention in which the indicium of the location of the first object is received at any time.

At task 703, first database 401 receives a query about the first space.

In accordance with the illustrative embodiment of the present invention, the first space is a geographic space defined by X and Y coordinates and is referred to by a name, such as, for example and without limitation, space 101-5 in map 100. In accordance with the illustrative embodiment of the present invention, the first database responds with X and Y boundaries of the requested space. These boundaries would be the Xₘᵢₙ, Xₘₐₓ, Yₘᵢₙ, and Yₘₐₓ of space 101-5 in map 100. Further in accordance with the illustrative embodiment of the present invention, the response to the query may comprise additional information, for example, and without limitation, information of other objects inside of space 101-5, etc.

Although, in accordance with the illustrative embodiment of the present invention, the space is defined in two dimensions (2-D) using Cartesian X and Y coordinates, it will be clear to one skilled in the art after reading this disclosure, how to make and use alternative embodiments of the present invention in the space is defined in more than two dimensional (2-D) space, for example and without limitation, three dimensions (3-D), four dimensions (4-D), etc.

At task 704, the response to the query is received by event processor 402.

At task 705, second database 403 is populated with the geographic information received in response to the query. In accordance with the illustrative embodiment of the present invention, the information placed into second database 403 is a subset of the information received from first database 401.

At task 706, event processor 402 receives a second indicium of the location of the first object. In accordance with the illustrative embodiment of the present invention, the first indicium of the first object is received at an initial time j. It will be clear to one skilled in the art, after reading this disclosure how to make alternative embodiments of the present invention in which the indicium of the location of the first object is received at any time. In accordance with the illustrative embodiment of the present invention, j>i, but it will be clear to one skilled in the art, after reading this disclosure how to make and use alternative embodiments of the present invention, in which j=i, j<i, etc.

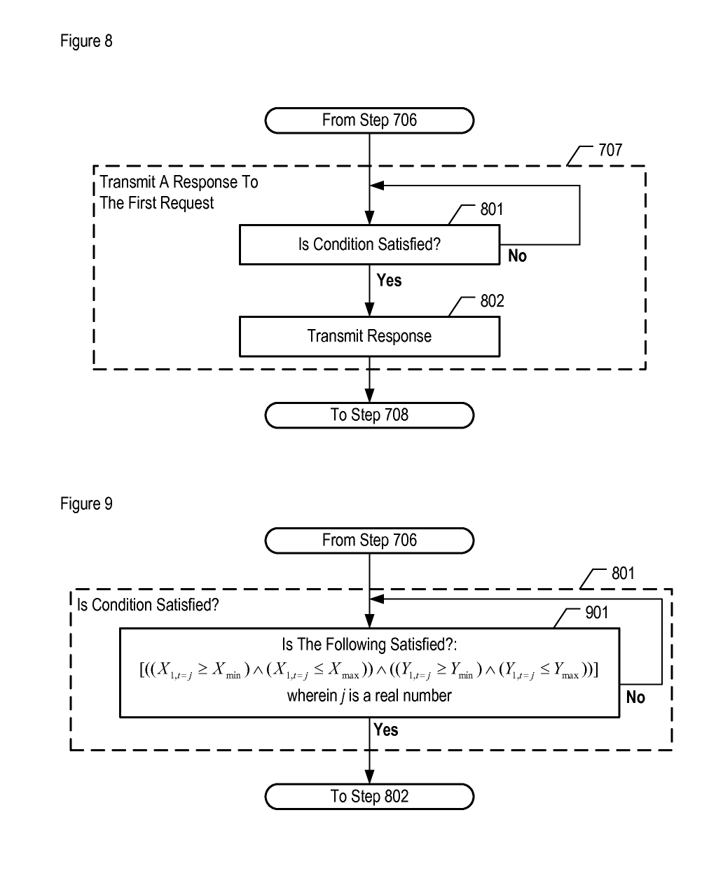

At task 707, a response is transmitted in response to the first request from event processor 402. This task is further detailed in FIG. 8 and FIG. 9.

At task 708, a second request is received to the first space at event processor 402.

At task 709, an indicium of the location of a second object is received at event processor 402.

At task 710, second database 402 is queried for the geographic information about the first space. In accordance with the illustrative embodiment of the present invention, the information retrieved in response to the query is subset of the information retrieved from first database 401 at task 703. It will be clear to one skilled in the art, after reading this disclosure how to make and use alternative embodiments of the present invention in which the information is retrieved from another location, for example and without limitation, first database 401, event processor 402, etc.

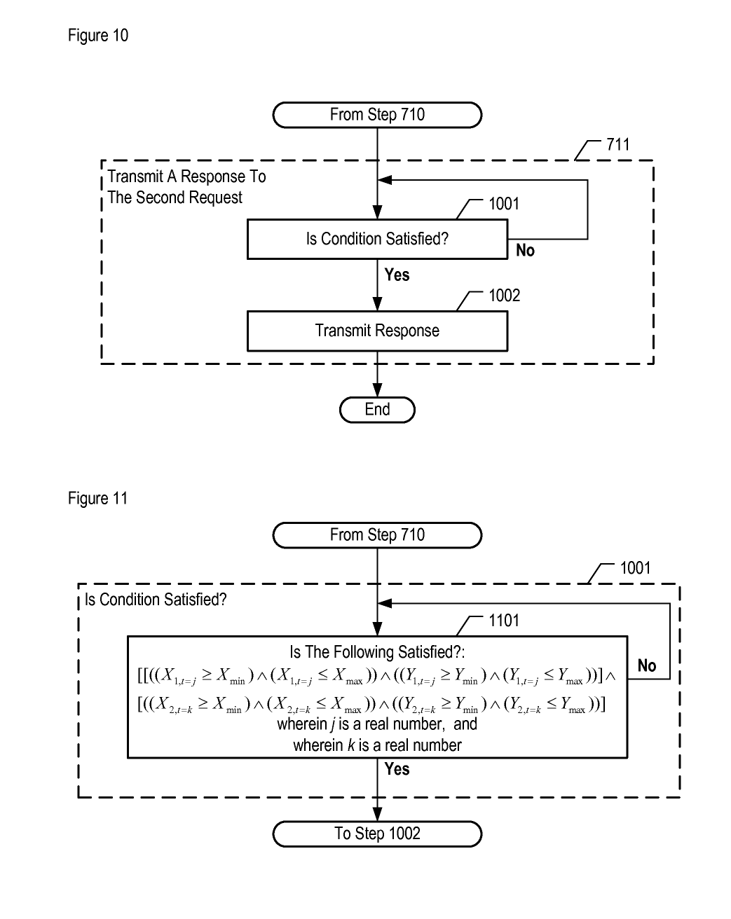

At task 711, a response is transmitted in response to the first request from event processor 402. This task is further detailed in FIG. 10 and FIG. 11.

It will be clear to one skilled in the art, after reading this disclosure, how to make and use other implementations of the present invention in which one or more of the steps are omitted or are performed in a different order than the one presented or simultaneously.

FIG. 8 depicts a flowchart of the salient tasks associated with the operation of task 707 in accordance with the illustrative embodiment of the present invention.

At task 801, it is determined whether or not the condition defined in task 701 to the first space is satisfied. If the condition is satisfied, it will proceed to task 802.

Although, in accordance with the illustrative embodiment of the present invention, task 801 is performed continuously until a single condition is satisfied, it will be clear to one skilled in the art, after reading this disclosure, how to make and use alternative embodiments of the present invention in which task 801 is performed any number of times, for example and without limitation, only once, a set number of times, each time an event occurs during a defined time period, etc. It will be clear to one skilled in the art, after reading this disclosure, how to make and use alternative embodiments of the present invention in which task 801 runs even after the condition is satisfied.

At task 802, a response is transmitted to the first request indicating the condition has been satisfied. Although, in accordance with the illustrative embodiment of the present invention, this entails sending a notification to a user which may be a person or an application, it will be clear to one skilled in the art, after reading this disclosure, how to make and use alternative embodiments of the present invention, in which the response is transmitted some other way, for example and without limitation, by e-mail, instant message, short-message-service message (SMS), etc.

It will be clear to one skilled in the art, after reading this disclosure how to make and use other implementations of the present invention in which one or more of the steps are omitted or are performed in a different order than the one presented or simultaneously.

FIG. 9 depicts a flowchart of the salient tasks associated with the operation of task 801 in accordance with the illustrative embodiment of the present invention.

At task 901, it is determined whether the location of the first object is in the space defined by the coordinates of the first space.

In accordance with the illustrative embodiment of the present invention, this condition is defined as: [((X_{1,t=j}≧Xₘᵢₙ) [symbol] (X_{1,t=j}≦Xₘₐₓ)) [symbol] ((Y_{1,t=j}≧Yₘᵢₙ) [symbol] (Y_{1,t=j}≦Yₘₐₓ))] and wherein j is any positive real number and wherein the test is performed at any time j. In accordance with the illustrative embodiment of the present invention, this test is performed continuously for any time j, where j increases as time passes.

Although the condition at task 901 is that the first object is within the X and Y coordinates of the first space, it will be clear to one skilled in the art, after reading this disclosure how to make and use alternative embodiments of the present invention in which task 801 is performed with different conditions, for example, and without limitation, that the object is NOT in the first space, that the object has entered and then exited the space, that the object is a second space, etc.

Although the condition is defined as above, it will be clear to one skilled in the art, after reading this disclosure, how to make and use alternative embodiments of the present invention in which the conditions of task 901 are defined in a different manner, for example, and without limitation, by a different coordinate system, etc.

Although in accordance with the illustrative embodiment of the present invention, the above condition is used, it will be clear to one skilled in the art, after reading this disclosure, how to make and use alternative embodiments of the present invention in which any condition is used.

FIG. 10 depicts a flowchart of the salient tasks associated with the operation of task 711 in accordance with the illustrative embodiment of the present invention.

At task 1001, it is determined whether or not the condition defined in task 607 to the first space is satisfied. If the condition is satisfied, it will proceed to task 1002.

At task 1002, a response is transmitted to the first request indicating the condition has been satisfied.

It will be clear to one skilled in the art, after reading this disclosure how to make and use other implementations of the present invention in which one or more of the steps are omitted or are performed in a different order than the one presented or simultaneously.

FIG. 11 depicts a flowchart of the salient tasks associated with the operation of task 1001 in accordance with the illustrative embodiment of the present invention.

At task 1101, it is determined whether the location of the first object is in the space defined by the coordinates of the first space.

In accordance with the illustrative embodiment of the present invention, this condition is defined as:

[[((X_{1,t=j}≧Xₘᵢₙ) [symbol] (X_{1,t=j}≦Xₘₐₓ)) [symbol] ((Y_{1,t=j}≧Yₘᵢₙ) [symbol] (Y_{1,t=j}≦Yₘₐₓ))]

[symbol]

[((X_{2,t=k}≧Xₘᵢₙ) [symbol] (X_{2,t=k}≦Xₘₐₓ)) [symbol] ((Y_{2,t=k}≧Yₘᵢₙ) [symbol] (Y_{2,t=k}≦Yₘₐₓ))]

wherein j is any positive real number and wherein the test is performed at any time j, and wherein k is any positive real number and wherein the test is performed at any time k. In accordance with the illustrative embodiment of the present invention, this test is performed continuously for any time j and time k, where j and k increase as time passes. Although, in accordance with the illustrative embodiment of the present invention, j=k, it will be clear to one skilled in the art, after reading this disclosure, how to make and use alternative embodiments of the present invention in which j≠k.

Although, in accordance with the illustrative embodiment of the present invention, j and k, are defined as being positive real numbers, it will be clear to one skilled in the art, after reading this disclosure, how to make and use alternative embodiments of the present invention in which j and k are defined as being in a given window of time, such as, for example and without limitation, Wₘᵢₙ<j, k<Wₘₐₓ.

Although in accordance with the illustrative embodiment of the present invention, the above condition is used, it will be clear to one skilled in the art, after reading this disclosure, how to make and use alternative embodiments of the present invention in which any condition is used.

Although the condition is that the first object and the second object are both within the X and Y coordinates of the first space, it will be clear to one skilled in the art, after reading this disclosure how to make and use alternative embodiments of the present invention in which task 1101 is performed with different conditions, for example, and without limitation, that one or both objects are NOT in the first space, that one or both objects have entered and then exited the first space, that one or both objects are in a second space, etc.

Although the condition is defined as above, it will be clear to one skilled in the art, after reading this disclosure, how to make and use alternative embodiments of the present invention in which the conditions of task 1101 are defined in a different manner, for example, and without limitation, by a different coordinate system, etc.

It is to be understood that the disclosure teaches just one example of the illustrative embodiment and that many variations of the invention can easily be devised by those skilled in the art after reading this disclosure and that the scope of the present invention is to be determined by the following claims.

1. A method comprising:
receiving, at an event processor, a first request that specifies a first space, R₁;
receiving a first indicium of location of a first object, L₁, at a time i, wherein i is a real number;
receiving information comprising the boundaries of the first space, R₁; and
transmitting a response, from the event processor, to the first request based on the location of the first object, L₁, and the boundaries to the first space, R₁.

2. The method of claim 1 wherein the boundaries of the first space, R₁, are geographic boundaries.

3. The method of claim 1 wherein receiving the information comprising the boundaries of the first space, R₁, is in response to a first query to a database, D₁.

4. The method of claim 1 wherein the first indicium of location of the first object, L₁, comprises coordinates.

5. The method of claim 1 wherein the response is transmitted when an additional condition is satisfied.

6. The method of claim 1 wherein the response is transmitted when the first indicium of the first object, L₁, indicates the presence of the first object within the boundaries of the first space, R₁.

7. The method of claim 1 further comprising receiving a second indicium of location of the first object, L₁, at a time j, and j>i.

8. The method of claim 7 wherein the response is transmitted when the second indicium of the first object, L₁, indicates the presence of the first object, L₁, in the boundaries of the first space, R₁.

9. The method of claim 1 further comprising:
receiving an indicium of the location of a second object, L₂, at a time k, and
wherein transmitting the response, from the event processor, is further based on the indicium of location of the second object, L₂.

10. The method of claim 1 further comprising populating a database, D₂, with a subset of the received information of the first space, R₁.

11. The method of claim 1 further comprising populating a database, D₂, with the geographic information of the first space, R₁.

12. The method of claim 11 wherein database, D₂, is comprised of an R-Tree.

13. The method of claim 11 further comprising:
receiving a second request to the first space, R₁; and
querying database, D₂, for the geographic information of the first space, R₁.

14. A method comprising:
transmitting a first request for a first resource, R₁, to a first database, D₁; and
populating a second database, D₂, with a subset of the first resource comprising the spatial information of the first resource.

15. The method of claim 14 wherein the subset of the first resource comprises the boundaries of a first space.

16. The method of claim 14 wherein the subset of the first resource is a proper subset.

17. The method of claim 14 wherein the second database, D₂, is an R-Tree data structure.

18. The method of claim 14 wherein the first request is based on a second request received at an event processor.

19. The method of claim 18 further comprising:
receiving a third request specifying the first resource at the event processor; and
transmitting a response to the third request based on the information from the second database, D₂.

20. The method of claim 14 further comprising:
receiving a first indicium of location of a first object, L₁, at a time i, wherein i is a real number; and
transmitting a response to the first request based on the location of the first object and the boundaries to a first space.
